(19) United States
(12) Patent Application Publication
(10) Pub. No.: US 2013/0006536 A1
(43) Pub. Date: Jan. 3, 2013

(54) HAND-HELD TEST METER WITH UNPOWERED USB CONNECTION DETECTION CIRCUIT

(75) Inventors: Ulrich KRAFT, Hofheim (DE); Manfred EBNER, Oberursel (DE)

(73) Assignee: LifeScan, Inc., Milpitas, CA (US)

(21) Appl. No.: 13/170,905

(22) Filed: Jun. 28, 2011

(51) Int. Cl. G06F 19/00

(52) U.S. Cl. 702/19

(57) ABSTRACT

A hand-held test meter for use with an analytical test strip in the determination of an analyte (such as glucose) in a bodily fluid sample (for example, a whole blood sample) includes a housing, a test meter control circuit block, and a Universal Serial Bus (USB) connector block that includes an unpowered USB connection detection circuit block. The unpowered USB connection detection circuit block is configured to provide a shielding signal of a first potential (for example, a high-level signal) to the test meter circuit control block when a USB connection to an external device has been made to the USB connector block and a shielding signal of a second potential (such as a low-level signal representative of ground) to the test meter control circuit block when a USB connection to a an device has been made to the USB connector block. In addition, the test meter control circuit block is configured to interrupt operation of the hand-held test meter when the shielding signal of the second potential is received from the USB connector block.

### BACKGROUND OF THE INVENTION

1. Field of the Invention

The present invention relates, in general, to medical devices and, in particular, to test meters and related methods.

2. Description of Related Art

The determination (e.g., detection and/or concentration measurement) of an analyte in a fluid sample is of particular interest in the medical field. For example, it can be desirable to determine glucose, ketone bodies, cholesterol, lipoproteins, triglycerides, acetaminophen and/or HbA1c concentrations in a sample of a bodily fluid such as urine, blood, plasma or interstitial fluid. Such determinations can be achieved using a hand-held test meter in combination with analytical test strips (e.g., electrochemical-based analytical test strips).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified depiction of a user employing a conventional hand-held test meter and an analytical test strip connected to an external device, i.e., an earth-grounded personal computer (PC);

FIG. 2 is a simplified schematic and block diagram illustrating a conventional hand-held test meter connected to a PC;

FIG. 3 is a simplified top view of a hand-held test meter according to an embodiment of the present invention;

FIG. 4 is a simplified block diagram of various electrical circuit blocks of the hand-held test meter of FIG. 3;

FIG. 5 is a simplified schematic and block diagram illustrating the hand-held test meter of FIG. 3 connected to a PC; and

FIG. 6 is a flow diagram depicting stages in a method for employing a hand-held test meter according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, hand-held test meters for use with an analytical test strip in the determination of an analyte in a bodily fluid sample according to embodiments of the present invention include a housing, a test meter control circuit block (e.g., a microcontroller block), and a Universal Serial Bus (USB) connector block that includes an unpowered USB connection detection circuit block. The unpowered USB connection detection circuit block is configured to provide (i) a shielding signal of a first potential (for example, a high-level signal equal to the hand-held test meter's supply voltage) to the test meter circuit control block in the absence of a USB connection between an external device and the USB connector block and (ii) a shielding signal of a second potential (such as a low-level signal representative of connection to ground) to the test meter control circuit block when a USB connection to an external device (either a powered or an unpowered external device) has been made to the USB connector block. In addition, the test meter control circuit block is configured to interrupt operation of the hand-held test meter when the shielding signal of a second potential is received from the USB connector block.

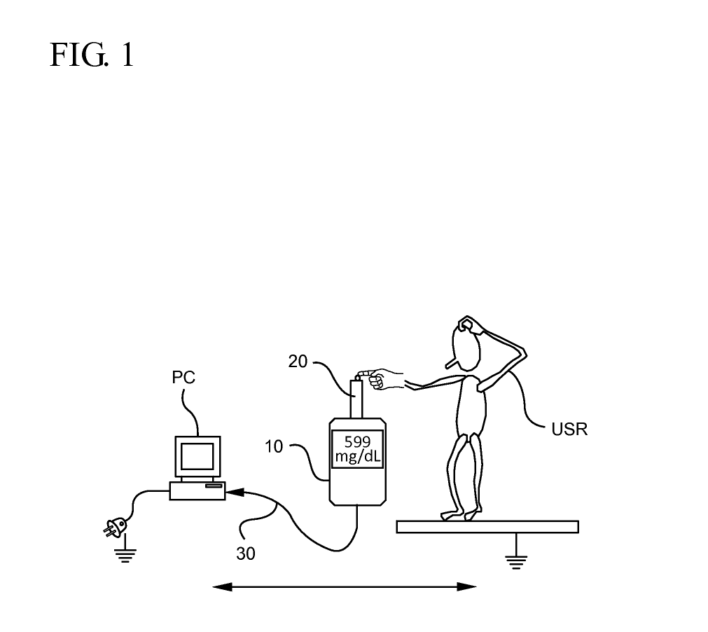

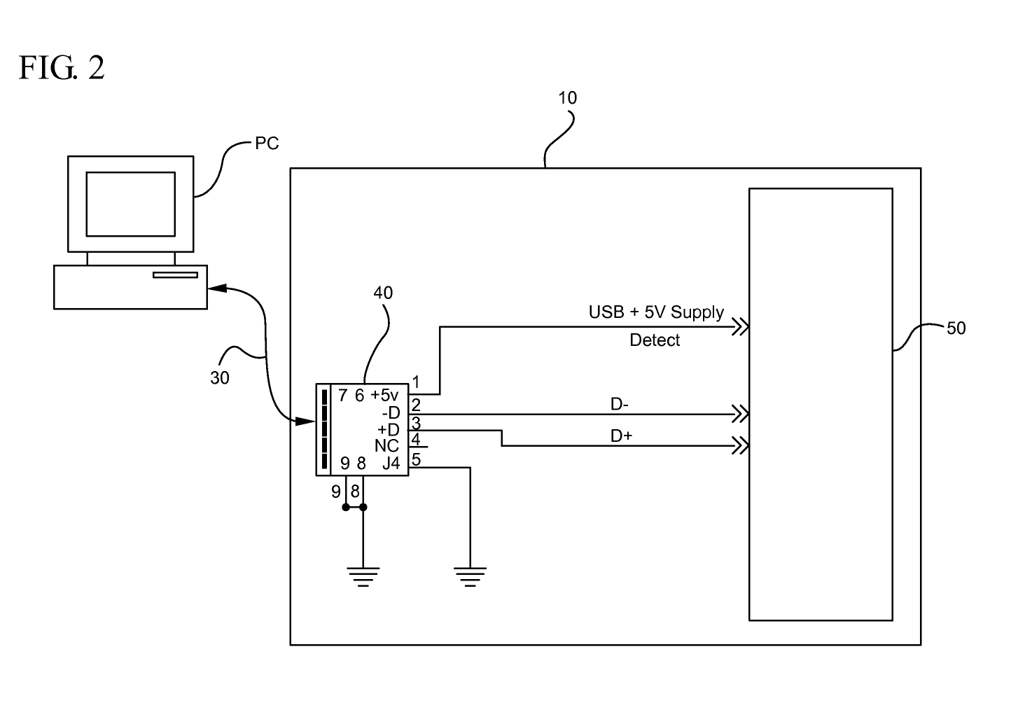

The general benefits of hand-held test meters according to embodiments of the present invention in detecting both unpowered and powered USB connections will be evident to one skilled in the art based on the following description and reference to FIGS. 1 and 2. FIG. 1 is a simplified depiction of a user (USR) employing a conventional hand-held test meter 10 and analytical test strip 20 with hand-held test meter 10 being connected to an earth grounded personal computer (PC) via USB connector cable 30. FIG. 2 is a simplified schematic and block diagram of conventional hand-held test meter 10 connected to a PC.

FIG. 1 illustrates a user (USR) that has not removed a finger from analytical test strip 20 during use of hand-held test meter 10. Although personal computer (PC) is unpowered (i.e., not activated), a deleterious leakage current can be introduced into hand-held test meter 10 by a closed electrical loop that communicates through hand-held test meter 10, USB connector cable 30 connecting hand-held test meter 10 to the unpowered PC, a PC to Earth/Grounding, and a user to Earth/Grounding. In FIG. 1, the portion of the closed electrical loop between the PC to Earth/grounding and the user to Earth/Grounding is depicted by a horizontal double-ended arrow. Such a leakage current can be, for example, the range of a few μA and can conceivably interfere with accurate analyte determination by the hand-held test meter.

FIG. 2 illustrates how a USB connector block 40 in hand-held test meter 10 is conventionally connected to a microcontroller 50 of the hand-held test meter. In such a conventional embodiment, the presence of a USB connection is detected by microcontroller 50 as a USB+5V supply signal and appropriate action taken. However, such a USB+5V supply signal is only present when USB connector block 40 is connected to a powered PC (or other powered external device such as a powered battery charger). If the PC, or other external device, is unpowered, the 5V USB supply voltage isn't present and the hand-held test meter cannot detect the USB connection, thus risking the deleterious scenario of FIG. 1.

Hand-held test meters according to embodiments of the present invention are beneficial in that they can detect the presence of a USB connection to both unpowered and powered external devices (such as an unpowered external PC or an unpowered external battery charger) and interrupt operation of the hand-held test meter, thus preventing potentially inaccurate analyte determinations.

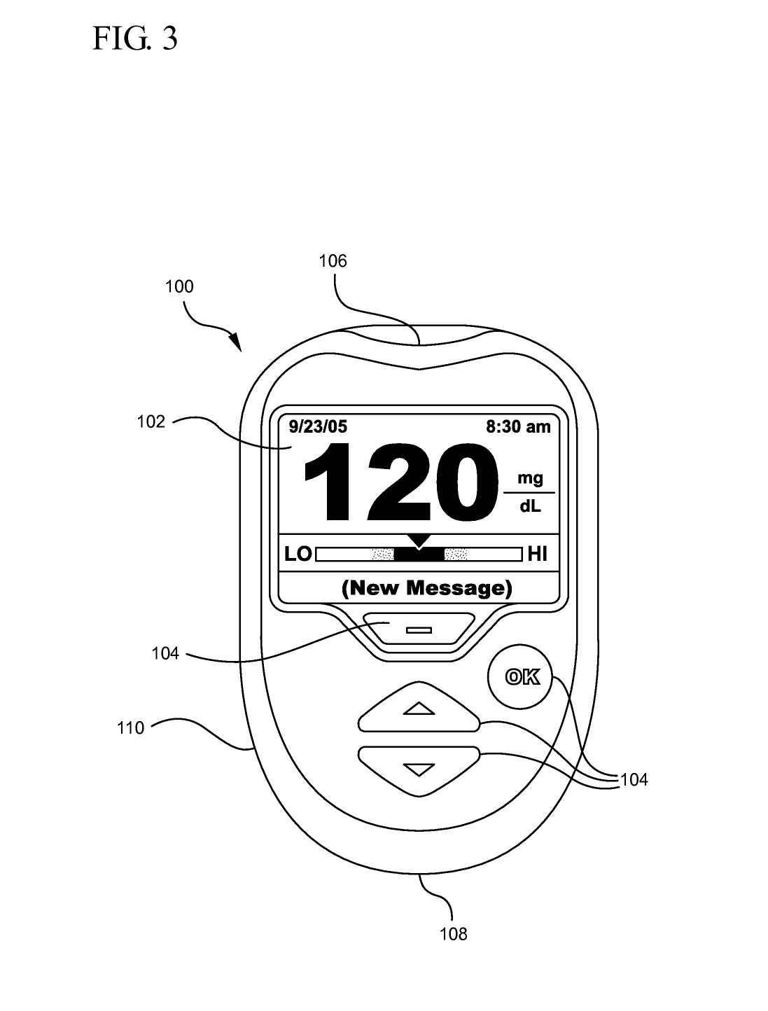

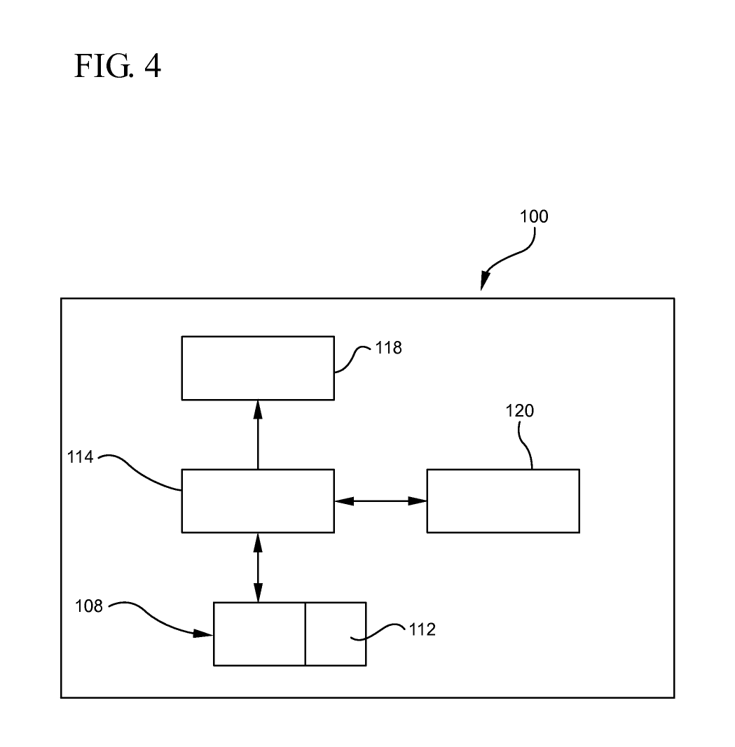

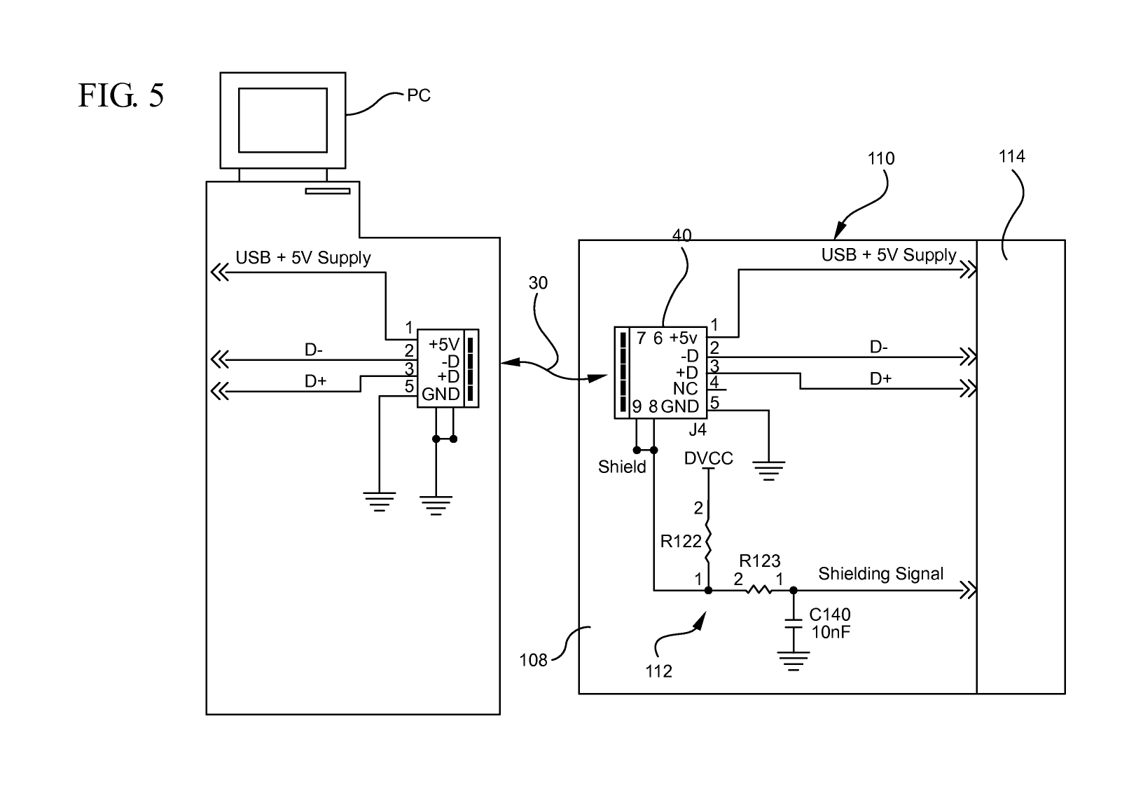

FIG. 3 is a simplified top view depiction of a hand-held test meter 100 with an unpowered USB connection detection circuit (also referred to as an unpowered USB connection detection circuit block) according to an embodiment of the present invention. FIG. 4 is a simplified block diagram of various blocks of the hand-held test meter 100. FIG. 5 is a simplified schematic and block diagram illustrating the hand-held test meter of FIG. 3 connected to a PC. Although unpowered USB connection detection circuits employed in embodiments of the present invention are useful in detecting both powered and unpowered USB connections, the unique and beneficial aspects of detecting unpowered USB connections is reflected in the term “unpowered USB connection detection circuit.”

Once one skilled in the art is apprised of the present disclosure, he or she will recognize that an example of a hand-held test meter that can be readily modified as a hand-hand test meter according to the present invention is the commercially available OneTouch® Ultra® 2 glucose meter from LifeScan Inc. (Milpitas, Calif.). Additional examples of hand-held test meters that can also be modified are found in U.S. Patent Application Publications No's. 2007/0084734 (published on Apr. 19, 2007) and 2007/0087397 (published on Apr. 19, 2007) and in International Publication Number WO2010/049669 (published on May 6, 2010), each of which is hereby incorporated herein in full by reference.

Hand-held test meter 100 includes a display 102, a plurality of user interface buttons 104, a strip port connector 106, a USB connector block 108, and a housing 110 (see FIG. 3). Hand-held test meter 100 also includes an unpowered USB connection detection circuit block 112 (considered part of USB connector block 108 as depicted in, for example, FIG. 4), a test meter control block 114 (in the form of a microcontroller block), a display control block 118, a memory block 120 and other electronic components (not shown) for applying a test voltage to an analytical test strip (not shown), and also for measuring an electrochemical response (e.g., a plurality of test current values) and determining an analyte based on the electrochemical response. To simplify the current descriptions, the figures do not depict all such electronic circuitry.

Display 102 can be, for example, a liquid crystal display or a bi-stable display configured to show a screen image. An example of a screen image may include a glucose concentration, a date and time, an error message, an electromagnetic interference detection warning message, and a user interface for instructing an end user on how to perform a test.

Strip port connector 106 is configured to operatively interface with the analytical test strip (not depicted in FIGS. 3 through 5) such as an electrochemical-based analytical test strip configured for the determination of glucose in a whole blood sample. Therefore, the analytical test strip is configured for operative insertion into strip port connector 106. The analytical test strip can be any suitable analytical test strip including an electrochemical-based analytical test strip such as the commercially available OneTouch® Ultra® glucose test strip from LifeScan Inc. (Milpitas, Calif.). Examples of analytical test strips can be found in U.S. Pat. Nos. 5,708,247; 5,951,836; 6,241,862; 6,284,125; 6,413,410; 6,733,655; 7,112,265; 7,241,265; and 7,250,105, each of which is hereby incorporate herein in full by reference.

Once an analytical test strip is interfaced with hand-held test meter 100, or prior thereto, a bodily fluid sample (e.g., a whole blood sample) is dosed into a sample-receiving chamber of the analytical test strip. The analytical test strip can include enzymatic reagents that selectively and quantitatively transforms an analyte into another predetermined chemical form. For example, the analytical test strip can include an enzymatic reagent with ferricyanide and glucose oxidase so that glucose can be physically transformed into an oxidized form.

Memory block 120 of hand-held test meter 100 includes a suitable algorithm that determines an analyte based on the electrochemical response of the analytical test strip.

As previously described, USB connector block 108 includes an unpowered USB connection detection circuit block 112 (see FIGS. 4 and 5 in particular). Unpowered USB connection detection circuit block 112 is configured to provide a shielding signal of a first potential to microcontroller block 114 in the absence of a USB connection between an external device and the USB connector block and a shielding signal of a second potential to microcontroller block 114 when a USB connection to an external device (such as an external PC or an external hand-held test meter battery charger) has been made to the USB connector block.

Moreover, microcontroller block 114 is configured to interrupt operation of the hand-held test meter when the shielding signal of a second potential is received from the USB connector block. For example, the shielding signal of a second potential can be a shielding signal with a potential representative of connection to ground and the microcontroller block can be configured to sense such a shielding signal of a second potential. In addition, the shielding signal of a first potential can be the hand-held test meter's supply voltage (typically 3V) or other suitable voltage.

If desired, the test meter control circuit block (for example, microcontroller block 114) can further configured to sense a +5V signal from the USB connector block when a USB connection to a powered device has been made to the USB connector block (see FIG. 5). This provides a secondary means for detecting a powered USB connection.

USB connector block 108 includes at five wire connection points, namely (1) +5V supply; (2) D− data line; (3) D+ data line; (4) an unused connection and (5) ground. However, as one of skill in the art will recognize, it is standard for a USB connector block 108 to includes a conductive outer shielding (not depicted in the FIGs.) configured to block electrical noise and for this conductive outer shielding to be electrically connected to a casing of the USB connector block. Connections to this shielding are labeled 8 and 9 in FIGS. 4 and 5. In embodiments of the present invention (such as that of FIG. 5), this outer shielding of the USB connector block is uniquely and beneficially employed in the generation of the shielding signal of a first potential and the shielding signal of a second potential.

In the embodiment of FIGS. 4 and 5, the shielding signal of the USB connector block 108 is internally pulled-up to the hand-held test meter's supply voltage level DVCC (e.g., 3V) via 10 k ohm resistor R122 in the absence of a USB connection between USB connector block 108 and an external device (such as the PC of FIG. 5). That logic “high-level” is sensed by microcontroller block 114 as a shielding signal of a first potential. However, such a shielding signal of a first potential is only present in the absence of a USB connection between a grounded external device (either powered or unpowered) and the USB connector block since creating a USB connection between the USB connector block and an external device will short circuit the USB connector shielding to a ground connection provided by the external device, thereby creating a shielding signal of a second potential, namely a second potential representative of connection to ground. Therefore, a shielding signal of a second potential is only provided to the test meter control circuit block when a USB connection to an external device has been made to the USB connector block. Such a USB connection to an external device is depicted in FIG. 5 as being accomplished with USB connector 30. In this embodiment, unpowered USB connection detection circuit block 112 also includes a low-pass filtering circuit (consisting of resistor 123 and capacitor C140).

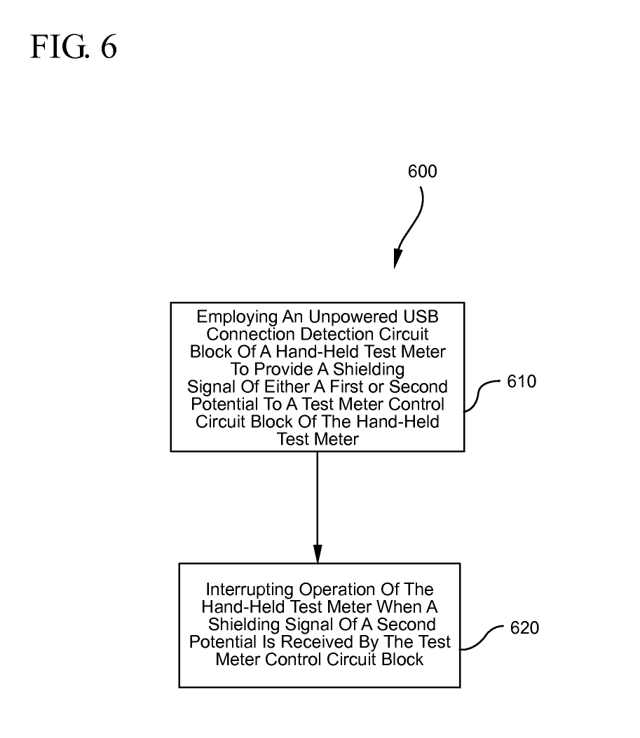

Once apprised of the present disclosure, one skilled in the art will recognize that the unpowered USB connection detection circuit block depicted in FIGS. 4 and 5 are for descriptive purposes only and that unpowered USB connection detection circuit blocks employed in embodiments of the present invention can take a form that differs in detail from that of FIGS. 5 and 6.

FIG. 6 is a flow diagram depicting stages in a method 600 for employing a hand-held test meter configured for the determination of an analyte (such as glucose) in a bodily fluid sample (for example, a whole blood sample). Method 600 includes employing a USB connector block, that includes an unpowered USB connection detection circuit block, of a hand-held test meter to provide a shielding signal of a first potential to a test meter circuit control block of the hand-held test meter in the absence of a USB connection between an external device and the USB connector block and a shielding signal of a second potential to the test meter control circuit block when a USB connection to an external device has been made to the USB connector block (see step 610 of FIG. 6).

At step 620, method 600 also includes interrupting operation of the hand-held test meter when the shielding signal of a second potential is received by the test meter control circuit block. Such interruption can, for example, include displaying an unpowered USB warning message to a user via a display of the hand-held test meter. In such a scenario, the hand-held test meter's unpowered USB connection detection circuit and test meter control circuit block, as well as a display control block, are configured to control the display of such a warning message.

Methods according to embodiments of the present invention can, if desired, also include the steps of (i) applying a bodily fluid sample to an electrochemical-based analytical test strip; (ii) measuring an electrochemical response of the electrochemical-based analytical test strip using the hand-held test meter; and (iii) determining the analyte based on the measured electrochemical response. Moreover, once apprised of the present disclosure, one skilled in the art will recognize that method 600 can be readily modified to incorporate any of the techniques, benefits and characteristics of hand-held test meters according to embodiments of the present invention and described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. A hand-held test meter for use with an analytical test strip in the determination of an analyte in a bodily fluid sample, the hand-held test meter comprising:
a housing;
a test meter control circuit block; and
a Universal Serial Bus (USB) connector block that includes an unpowered USB connection detection circuit block,
wherein the unpowered USB connection detection circuit block is configured to provide a shielding signal of a first potential to the test meter circuit control block in the absence of a USB connection between an external device and the USB connector block and a shielding signal of a second potential to the test meter control circuit block when a USB connection to an external device has been made to the USB connector block; and
wherein the test meter control circuit block is configured to interrupt operation of the hand-held test meter when the shielding signal of the second potential is received from the USB connector block.

2. The hand-held test meter of claim 1 wherein the external device is a grounded external device.

3. The hand-held test meter of claim 2 wherein the grounded external device is a grounded unpowered personal computer (PC).

4. The hand-held test meter of claim 2 wherein the grounded external device is a grounded unpowered hand-held test meter battery charger.

5. The hand-held test meter of claim 1 wherein the external device is configured to provide en electrical connection between a shield connector and a ground connector of a USB connector providing the USB connection.

6. The hand-held test meter of claim 1 wherein the shielding signal of a first potential is a high level signal and the test meter control circuit block is configured to sense the shielding signal of the first potential.

7. The hand-held test meter of claim 1 wherein the shielding signal of a second potential is a low level signal representative of connection to ground and the test meter control circuit block is configured to sense the shielding signal of a second potential.

8. The hand-held test meter of claim 1 wherein the test meter control circuit block is a microcontroller block.

9. The hand-held test meter of claim 8 further including a display and a display module block, and
wherein the microcontroller block, display module block and display are configured to display a warning message to a user when the shielding signal of a second potential is received from the USB connector block.

10. The hand-held test meter of claim 1 wherein the first potential is a test meter supply voltage potential and the second potential is a ground potential.

11. The hand-held test meter of claim 1 wherein the hand-held test meter further comprises:
a meter supply voltage level block; and
wherein the first shielding signal of a first potential is pulled to the first potential by connection to the meter supply level block in the absence of a USB connection between an external device and the USB connector block; and
wherein by the shielding signal is pulled to the second potential when a USB connection to an external device has been made to the USB connector block.

12. The hand-held test meter of claim 1 wherein the unpowered USB connection detection circuit includes a low pass filtering circuit.

13. The hand-held test meter of claim 1 wherein the hand-held test meter is configured for the determination of glucose in a whole blood sample using an electrochemical-based analytical test strip.

14. A method for employing a hand-held test meter configured for the determination of an analyte in a bodily fluid sample, the method comprising:
employing a USB connector block, that includes an unpowered USB connection detection circuit block, of a hand-held test meter to provide a shielding signal of a first potential to a test meter circuit control block of the hand-held test meter in the absence of a USB connection between an external device and the USB connector block and a shielding signal of a second potential to the test meter control circuit block when a USB connection to an external device has been made to the USB connector block; and
interrupting operation of the hand-held test meter when the shielding signal of the second potential is received by the test meter control circuit block.

15. The method of claim 14 further including:
applying a bodily fluid sample to an electrochemical-based analytical test strip;
measuring an electrochemical response of the electrochemical-based analytical test strip using the hand-held test meter; and
determining the analyte based on the measured electrochemical response.

16. The method of claim 14 wherein the bodily fluid sample is a whole blood sample and the analyte is glucose.

17. The method of claim 14 wherein the test meter control circuit block is a microcontroller block.

18. The method of claim 14 wherein the interrupting step includes interrupting the operation of the hand-held test meter by displaying an unpowered USB warning message on a display of the hand-held test meter.

19. The method of claim 14 wherein the external device is a grounded unpowered personal computer.

20. The method of claim 14 wherein the external device is a grounded unpowered hand-held test meter battery charger.

21. The method of claim 14 wherein the external device is configured to provide en electrical connection between a shield connector and a ground connector of a USB connector providing the USB connection.

22. The method of claim 14 wherein the first potential is a test meter supply voltage potential and the second potential is a ground potential.

23. The method of claim 14 wherein the shielding signal of a second potential has a potential representative of connection to ground and the test meter control circuit block is configured to sense the shielding signal.

24. The method of claim 14 wherein the shielding signal of a first potential is a high level signal and the test meter control circuit block is configured to sense the shielding signal.
